(19) United States
(12) Patent Application Publication
(10) Pub. No.: US 2005/0067364 A1
(43) Pub. Date: Mar. 31, 2005

(54) Assembly for the removal and replacement of huge and heavy components

(76) Inventor: Carlo Leoni, Al-Jubail (SA)

Correspondence Address: KRAMER LEVIN NAFTALIS & FRANKEL LLP;INTELLECTUAL PROPERTY DEPARTMENT, 919 THIRD AVENUE, NEW YORK, NY, 10022, US

(21) Appl. No.: 10/912,328

(22) Filed: Aug. 5, 2004

(30) Foreign Application Priority Data
Aug. 8, 2003 (EP) 03017587.1

(51) Int. Cl. B66C 17/00

(52) U.S. Cl. 212/312

(57) ABSTRACT

The present invention relates to a replacement assembly for the removal and/or replacement of huge and/or heavy components, in particular as part of a construction or plant unit, comprising at least two mobile support means each of which comprises a mobile unit, in particular at least two wheels which are adapted to be aligned in a row with regard to the moving direction, at least one fastening means adapted to be reversibly fixable, in particular clamped, to, in particular the back part of, said component, and at least one connecting device adapted to connect the mobile unit and the fastening means, and at least one mounting rail which comprises a lifting device, in particular a hoist, which is moveably supported on said mounting rail and which has connecting means being detachably lockable to, in particular the front part of, said component, in particular via at least one lug, and which is adapted to hold said component from above. The invention further relates to a method for the removal and/or replacement of a huge and/or heavy component, in particular as part of a construction or plant unit.

The present invention relates to an assembly for the removal and/or replacement of huge and/or heavy components, in particular valves in construction or plant units, and also to a method for removing and/or replacing said components.

There exists a multitude of production plants in a variety of different industrial sectors which are designed for large-scale production, e.g. in the chemical or petrochemical industry. Most of the starting materials, products or heating and cooling means required in such production plants are transferred via pipes and tubes and are regularly distributed with the aid of pumps and manifolds. Also, valves usually form an integral part of such production units. From time to time production plants have to be shut down because of maintenance or repair work. The bigger and heavier the equipment to be replaced or maintained the more time is needed and the more effort has to be spent until regular working conditions are restored. For example, gate valves which are used in the petrochemical industry and which can have a weight of around 14 t are usually replaced using a lot of heavy chain blocks, as well as slings and scaffolds. In addition, such replacement work requires the assistance of a large working group. Moreover, traditional replacement conditions for such heavy equipment, for example of production plants, has quite often to be conducted in a highly congested area and is therefore prone to accidents. Also, care has to be taken that no surrounding equipment is destroyed. Furthermore, it has emerged as a problem that for heavy and/or huge equipment many scaffolds as well as many slings are required which, however, not only increase the amount of replacement equipment necessary but also create a very dangerous working environment.

From RU 2132926 C1 a device for the replacement of gusher equipment valves, which are used in the oil and gas production industry, is disclosed. According to RU 2132926 C1 a defective valve in a gusher equipment at well head under pressure can be replaced with a coupling screw, threaded rods and a sealing member. From U.S. Pat. No. 5,161,294 a tool device for use in replacing a device which is surrounded by an instrument housing which may be coupled into fluid line, is known. However, none of the cited documents is concerned with the replacement of heavy equipment, such as huge and heavy valves.

Thus, there is a serious need for an improved replacement equipment for huge and heavy components which circumvent the problems of the state of the art.

Therefore, it has been an object of the present invention to find a replacement equipment for huge and heavy components which allows for an easy, safe and also fast removal or replacement of said components without the need to rely on a large working group, extensive equipment and severe safety measures. In particular, it is an object of the present invention to fulfill the above goals when the replacement or removal work has to be conducted on a rather small or congested area.

These and other objects are accomplished by a replacement assembly for the removal and/or replacement of huge and/or heavy components, in particular as part of a construction or plant unit, comprising
a) at least two mobile support means each of which comprises a mobile unit, in particular at least two wheels which are adapted to be aligned in a row with regard to the moving direction, at least one fastening means adapted to be reversibly fixable, in particular clamped, to, in particular the back part of, said component, and at least one connecting device adapted to connect the mobile unit and the fastening means, and
b) at least one mounting rail which comprises a lifting device, in particular a hoist, which is moveably supported on said mounting rail and which has connecting means being detachably lockable to, in particular the front part of, said component, in particular via at least one lug, and which is adapted to hold said component from above.

The huge and/or heavy components encompass a variety of equipment which is, for example, in use in construction or plant units, such as valves, manifolds, tubes or tube elements, and also generators, motors, cooling or heating systems.

In one preferred embodiment of the invention at least two mobile support means are located spaced apart and are adapted to be releasably fixed to opposite, in particular lateral, portions of said component. The mobile support means are suited to carry at least the weight of one part, in particular the back part, of the component. Said support means are preferably lockably fixed to the component such that the weight is essentially evenly distributed on both or all mobile support means. In another embodiment the oppositely located mobile support means can be temporarily connected to each other, e.g. via a rod. Also, these oppositely fixed and located mobile support means can have a maximum distance given by the dimension of the component, but can also be arranged in close vicinity depending on the replacement environment and/or the component to be replaced.

In a particularly preferred embodiment the connecting device is extractable, in particular by use of a hand wheel. The use of a connecting device which, similar to a telescope, can vary its length, offers the advantage that each mobile support device can be adapted to individual replacement requirements. If for example the fastening means of different mobile support means cannot be attached to the component at the same height each connecting device can be adjusted to such different conditions. In one embodiment the connecting device is provided with a hand wheel with which a screw system placed inside the connecting device can be used to extend or reduce the length of said connecting means. By the design and size of the wheel as well as the screw system the extractable connecting means can be adapted to different component weights. With the above connecting devices it is possible to easily choose the most appropriate replacement tool for each individual equipment to be replaced.

Provisions may be made that the mobile unit is detachably lockable to the connecting device, in particular to the lower portion of the connecting device, and/or that the connecting device, in particular the upper portion of the connecting device, is detachably lockable to the fastening means. In case the mobile support means is made from separate individual parts, like the mobile unit, the connecting device and the fastening means, those parts can be assembled which are most suited for a specific replacement task. In particular, while the mobile unit and the fastening means can be used for a variety of different components to be replaced, different connecting devices can be used if the weight of the components to be replaced differ to a great extent. In another embodiment the mobile unit and the connecting device can be left unaltered during different replacement tasks while it is advantageous to exchange the fastening means depending on the fixing requirements on the component.

Therefore, according to one aspect of the invention the fastening means are bonnet connecting clamps.

It is furthermore preferred that the mobile support means, in particular when having the form of wheels, are adapted to be moved on rails or run ways. Especially, when very heavy equipment is to be replaced rails and run ways are suited to guide the movement of the mobile support means.

It is further provided that the mounting rail can for example be linear or bent. Usually, the mounting rail has the form of a beam and is of linear geometry. The beam or mounting rail usually commences above one side of the heavy component, preferably its front part, and is directing in the direction of the replacement movement of the component. If, for example, only little space is left in front of the heavy component, e.g. due to a congested construction unit area, the mounting rail or beam can also be bent. In this case also the rails or run ways for the mobile units should be bent having the same curvature. In general, it is preferred that if two oppositely arranged mobile support means are used to carry the weight of the component at its back part, the mounting rail is arranged above said component and located between both above support means.

In another aspect of the present invention the replacement assembly also comprises a surface for the movement of the mobile units of the mobile support means capable of having a load.

It is thus provided an embodiment of the present invention in which the surface on which the mobile support means are placed can be supported by a scaffold. It has been found to be advantageous to reinforce the surface onto which the rails or run ways can be placed with a scaffold if the weight of the component exceeds a safety limit. Also, in case there is no surface at all adjacent to the component to be replaced or removed onto which the mobile support means can be placed such a surface can be installed by use of a scaffold.

Further provisions may be made that the surface comprises, in particular wooden, supporting planks, in particular above a grating, and/or fails, run ways and/or foot guides.

The assembly of the invention can further comprise a trolley which is adapted to hold at least one component after removal or replacement. After a heavy component has been removed it is usually transferred to a place remote from a plant unit where, for example, maintenance work can be conducted. If the component to be replaced is close to ground level such a trolley can be-used directly for transferal. When the replacement work takes place above ground level the removed component can be transferred by use of a trolley to a place which is best suited for a crane to be attached to said component.

In another preferred embodiment the replacement assembly according to the invention further comprising at least one, in particular cylindrical, supporting segment, in particular a supporting pipe which is adapted to be mounted to, in particular the front part of, the component and which is further adapted to be connected to a lifting device, e.g. a hoist, and/or to an additional chain block. Especially when the heavy or huge component is not well suited to be directly connected to a hoist, in particular at that part which is opposite to where the mobile support means are affixed, it has proven to be advantageous to mount a supporting pipe to said component. The supporting pipe can also be used to control the movement of component during replacement work more accurately.

In a preferred embodiment the supporting segment, in particular a supporting pipe, is mounted to the flange, in particular to the flange of an inspection port, of a valve. As components of constructions plants, like for example valves are usually provided with a multitude of different functionalities, it has been found that these functionalities can also be used to allow the attachment of a supporting segment. Instead or in addition separate connecting sites, such as lugs, can also be provided on the component as such.

The objects according to the invention are also accomplished by a method for the removal and/or replacement of a huge and/or heavy component, in particular as part of a construction or plant unit, which comprises the steps of
a) installation of at least two mobile support means at opposite sides of said component, in particular adjacent to the back part of said component,
b) connecting, in particular an upper portion, which in particular lies above the center of gravity of the component, in particular a central upper portion of, said component, to a mounting rail via a lifting and connecting means which is adapted to lift and hold said component, whereby the mounting rail is directing away from said component and/or is located above the component, in particular located between mobile support means which are installed at opposite sides of said component, and having at least a length essentially equivalent to the length of said component,
c) lifting, in particularly only slightly, of said component by extending the mobile support means, in particular the connecting devices of said mobile support means, and by, in particular simultaneously, lifting the front part of said component by use of the lifting and connecting means which is connected to the mounting rail, in particular by a hoist, and
d) pull and/or push said component out of its seat, in particular by an additional chain block which is moveable on the mounting rail, in the direction of the mounting rail to the front or back part of said component.

If there is no space left for removal of the component at that part of said component where the mobile support means are installed, hereinafter also referred to as back part, the mounting rail is preferably mounted in front of the front part of the component thereby directing away from the component. In case there is no space left for removal at the front of the component the mounting rail can also be placed above said component which allows for a replacement movement in the direction of back part of the component. Usually, one mounting rail already suffices to be used with the replacement assembly of the invention, however also two and more mounting rails can be used, in particular in parallel, to lift and carry heavy and huge components.

It is especially preferred to conduct steps a) and/or b) of the method according to the invention partially or completely during the plant cooling down time or even when the plant is operating, e.g. if the cooling down time is neglectable or is very short. It is of great advantage to be able to already install the mobile support units or parts thereof and/or the hoist or the additional chain block while the component to be replaced is still working or is cooling down. Thus, also by this preparative work the effective shutdown time can be dramatically reduced.

In general, valve or manifolds may represent huge and/or heavy components to be replaced. These huge and/or heavy components may have a weight of above 1 t, in particular of above 12 and even of about 14 t or even above 14 t.

In one embodiment of the invention the mobile support means comprises, in particular as individual, detachably lockable parts, a mobile unit, in particular at least two wheels which are adapted to be aligned in a row with regard to the moving direction, at least one fastening means adapted to be reversibly fixable, in particular clamped, to, in particular the back part of, said huge. ELd/or heavy component, and at least one connecting device adapted to connect the mobile unit and the fastening means.

Provisions may be made that at least two fastening means of separate mobile support means are fixed to, in particular adjacent to the back part of, the component at opposite sides, at least two mobile units are each positioned essentially beneath or adjacent to said fastening means being fixed to the component, at least two extractable connecting devices are each detachably mounted to said mobile units, and are extended, in particular by a hand wheel, up to, in particular a bearing of, the fastening means and joined to said fastening means.

According to another embodiment of the invention at least two fastening means of separate mobile support means are fixed to, in particular adjacent to the back part of, the component at opposite sides, at least two mobile units which are each irreversibly or reversibly connected to extractable connecting devices are each positioned essentially beneath or adjacent to said fastening means being fixed to the component, and wherein the connecting means are extended, in particular by a hand wheel, up to, in particular a bearing of, the fastening means and joined to said fastening means.

It has been found to be preferable when a lifting device, in particular a hoist, and/or an additional chain block can be automatically, controllably and/or adjustably driven along the mounting rail, in particular by aid of an electric motor.

In another preferred embodiment at least one supporting segment, in particular a supporting pipe, is, in particular reversibly, mounted to, in particular the front part of, the component, and wherein the hoist and/or the additional chain block is/are attached to said supporting pipe and/or, in particular front part of, the component, at least during replacement and or removal work.

The present invention is based on the surprising perception that by use of a very limited number of replacement tools very huge and heavy components of, for example production plants, can be easily, quickly and safely replaced even with limited man power. Also, the shutdown time for production plants can be reduced to a considerable extent, thereby minimizing the production loss. Furthermore, the entire removal or replacement process is less hazardous and therefore much safer than traditional maintenance or repair techniques for huge and heavy equipment. It is another advantage of the present invention that the individual components of the inventive replacement device can be assembled rather quickly and in a straightforward manner, also allowing the repair or maintenance of heavy and huge components in congested areas. In general, with the present replacement device, the problems of the state of the art can be overcome in a very safe and economical manner.

### BRIEF DESCRIPTION OF THE DRAWINGS

A more complete appreciation of the invention and many of the attended advantages thereof will be readily understood by reference to the following detailed description when considered in connection with the accompanying drawings in which alike numerals in different figures represent the same structures or elements, wherein:

FIG. 1 is a side view of a replacement device according to the invention when mounted to a valve;

FIG. 2 is a side view of a fastening means of the replacement device of FIG. 1;

FIG. 3 is a drawing of one mobile unit of the replacement device of FIG. 1;

FIG. 4 is a cross-sectional view of a part of a mobile support means of the replacement device of FIG. 1;

FIG. 5 is a top view of the replacement device of FIG. 1 when mounted to a valve;

FIG. 6 is a top view of the valve to be replaced; and

FIG. 7 is a cross-sectional view of the bottom part of the mobile support means.

### DETAILED DESCRIPTION OF THE INVENTION

The replacement or removal of heavy and/or huge components requires great care in order not to damage either the component to be replaced, repaired or maintained, or the equipment which surrounds said component in a construction or process plant. With a device according to the invention heavy components, e.g. a valve, are preferably fixed to the replacement device at a front and a back part. In the meaning of the present invention, a front part of a component is defined by the direction into which the valve in general is moved for its replacement. However, given that the conditions for a movement in the direction of the front part are not well suited replacement can also take place in the direction of the back part.

The invention having been generally described, the following examples are as particular embodiments of the invention and to demonstrate practice and advantages thereof. It is understood that the examples are given by way of illustration and are not intended to limit the specification or the claims to follow in any manner.

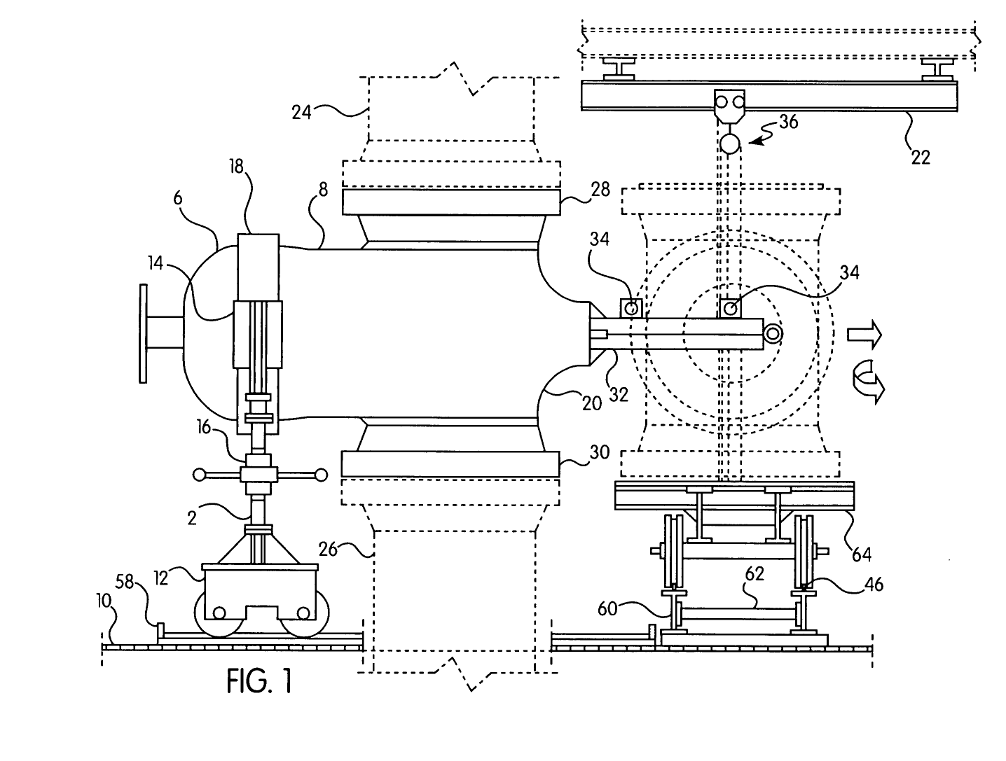

Assembly 1 for the replacement or removal of a valve as shown in FIG. 1 comprises two mobile support means 2 and 4 (not shown), each located on opposite sides at the back part 6 of the valve 8, a surface 10 on which the support means 2 and 4 can be moved on. The mobile support means 2 and 4, respectively, comprise a mobile unit 12 having two wheels which are aligned in a row in the direction for replacement, a fastening means 14 and a connecting device 16. The fastening means is mounted to a flange 18 of the valve 8. The mobile unit 12 and the fastening means 14 are joined via connecting device 16. A suitable fastening means 14 is a connecting clamp which can be fixed to one side at the back part of the valve 8, for example to a flange of said valve, as depicted in FIG. 1. The connecting device 16 which forms the intermediate part of the mobile support means is extractable. In front of and above the valve 8 and oriented in the replacement direction is a mounting rail 22 to which the front part 20 of the valve 8 is joined by a hoist 36. The mounting rail 22 mainly carries and takes up the weight of the front part of the valve 8. The mounting rail 22 according to FIG. 1 is straight and is directing away from the front part of the valve. Depending on the design of the front part of the valve 8 a supporting device 32, for example a supporting pipe, can be mounted to said front part thereby alleviating the fastening of a chain. The front part of the valve 8 and the supporting pipe 32 are provided with lugs 34 to which a chain or a hoist can be connected. Moreover, a metal chain is also joined to a movable transport unit on the mounting rail to facilitate moving of the valve 8. As can be derived from FIG. 1 valve 8 represents an integral part of a tube system (drawn in phantom) which is essentially vertically aligned. The valve 8 is attached to the upper and lower tube 24 and 26 (shown in phantom) via flanges 28 and 30. The bolts of these flanges have been removed prior to the replacement of the valve 8. A mobile support means 4 (not shown) similar to the one depicted in FIG. 1 is oppositely installed on the adjacent valve side. Onto the surface 10 a pair of rails is mounted which guide the wheels of the mobile unit during the replacement movement. The surface 10 is capable of bearing great loads. Such a surface can be provided for example by a scaffold if there is no appropriate surface already installed in the vicinity of the valve to be replaced, or by a platform permanently installed at the valve. For the sake of clarity the surface in front of the lower tube 26 is only depicted with dotted lines. The surface 10 as shown in FIG. 1 extends from an area at the back part of the valve 8 where the mobile support means 2 and 4 are fastened to an area at the front part of the valve so that there is enough place for a safe removal of the valve. As soon as the weight of the valve 8 is on the mobile support means 2 and 4 at the back part and on the mounting rail 22 at the front part of the valve 8, and does no longer rest on the flange of the lower tube 26, the removal of the valve 8 is ready to take place. FIG. 1 also shows in phantom a completely detached valve 8 which has been turned at 90° and placed on a trolley 64.

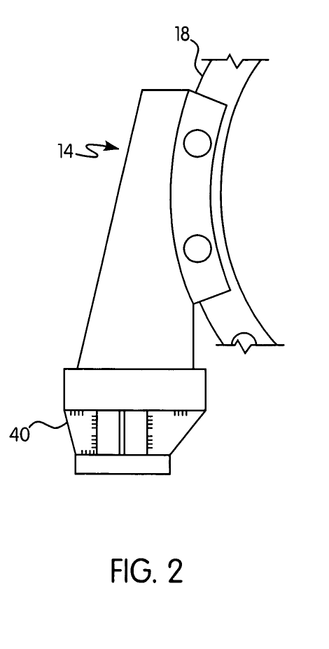

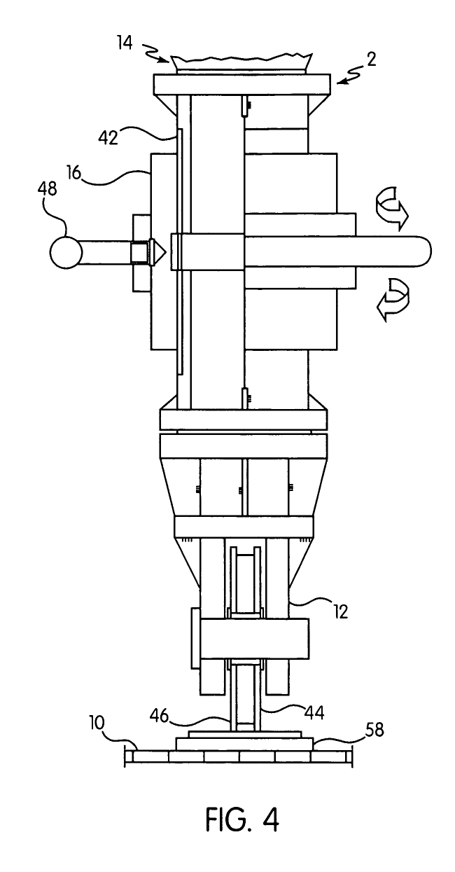

In FIG. 2 a fastening means 14 is shown in the form of a connecting clamp from a side perspective. The connecting clamp 14 is fastened to a flange 18 of the valve 8 by two bolts which are preferably aligned beneath each other on an essentially vertical line. The connecting clamp 14 further comprises at its bottom part 40 a means for being coupled with the upper part 42 of the connecting device 16 (s.a. FIG. 4). The bottom part 40 of the connecting clamp 14 has a concavity which is open towards the bottom side and into which the rod-like upper part 42 of the connecting device 16 can be detachably introduced.

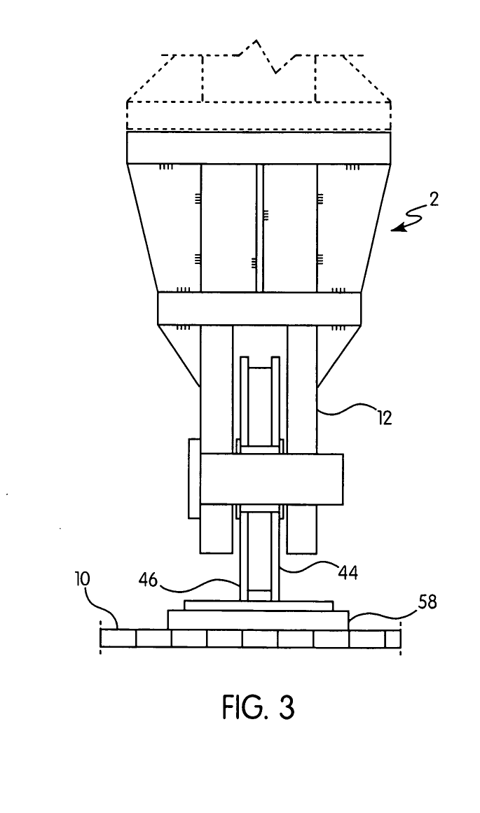

In FIG. 3 the mobile unit 12 of a mobile support means 2, 4 is shown in the direction of its movement. As the mobile unit 12 a wheel 44 is used which is adapted to run on rails 46. The cross-section of the wheel is designed in such a way that a lateral movement is prevented. With this embodiment also a very heavy load can be safely removed from its original position.

In FIG. 4 a partial cross-section of a mobile support means 2 is shown comprising the mobile unit 12 having a wheel 44 and an extractable connecting device 16. The mobile unit 12 comprising a wheel is fixedly attached to the connecting device 16. The connecting device 16 is arranged in such a way that it can be extended for example with a hand-turning wheel 48 which is connected to a screw mechanism adapted to enlarge or decrease the length of the connecting device. Also, a pneumatic or hydraulic telescope mechanism can be employed. By extending the length of the connecting device 16, the upper part 42 of this device can be safely linked to the connecting clamp 14 (only partially depicted) which is fixed to the valve 8. The position of the connecting device 16 and the mobile unit 12 can be manually adjusted in a very precise manner. In addition, as a foot guide for the mobile support means the rails 46 can be placed on top of one or more wooden planks in order to prevent the underlying surface 10, e.g. of a scaffold, from damage.

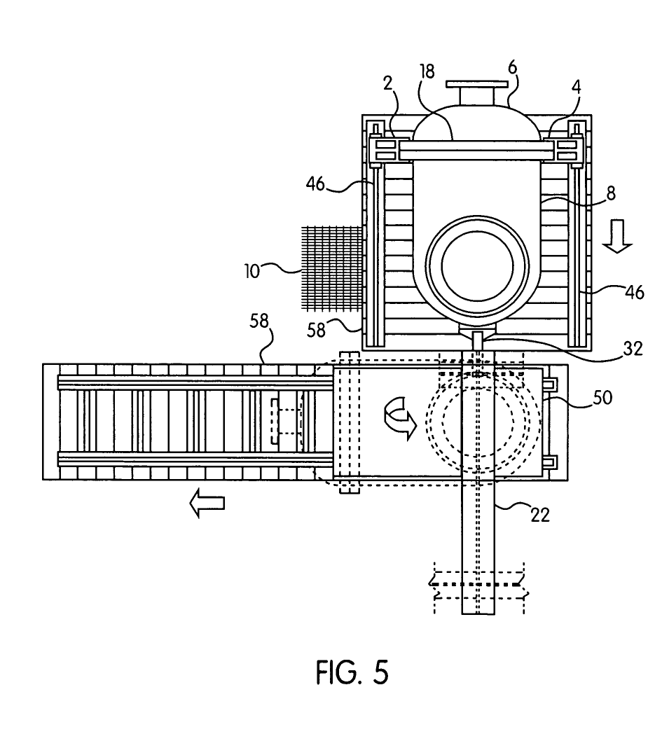

In FIG. 5 the assembly according to FIG. 1 can be seen from above. Two rails 46 are aligned in parallel, each rail being besides the valve 8. Two mobile support means 2 and 4 are located at the back part 6 of the valve 8 and are attached to opposite sides. The mounting rail 22 is centrally located between both rails for the mobile support means, however, above the valve 8. The length of the mounting rail 22 essentially corresponds to the length of both rails 46. As soon as the valve 8 is removed from the tube system it can be placed on a trolley 50 and, if necessary, be rotated to be best suited for further transport (shown in phantom).

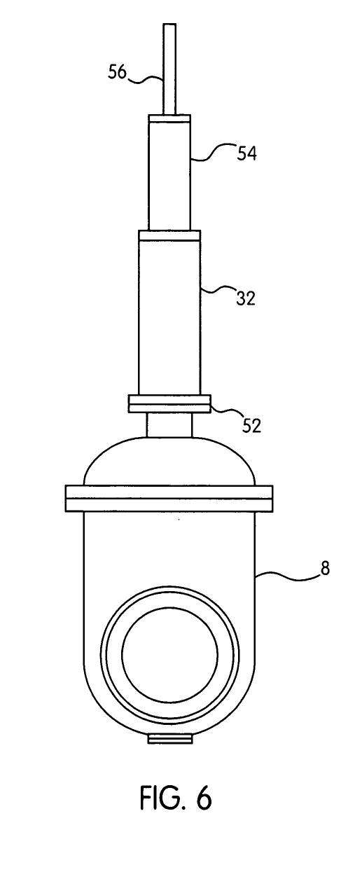

In FIG. 6 the valve 8 to be replaced by the assembly 1 according to the invention is depicted from above. To the front part of said valve a supporting pipe or yoke 32 is attached, preferably via a flange 52 onto which it can be mounted. The valve can be removed even more easily if the voke 32 also comprises hydraulic actuators 54, 56, which can be moved out of the yoke in a telescopic fashion. Such a yoke 32 can be handled very easily when telescoped into one another, and renders stability to the replacement device when extended. Also, by use of such a telescopic yoke the assembly 1 can be adapted to various working environments depending on the work space in the periphery of the valve to be replaced. For example, the telescopic yoke 32 can be attached to the mounting rail 22 via not only one, but several hoists 36 or other connecting means.

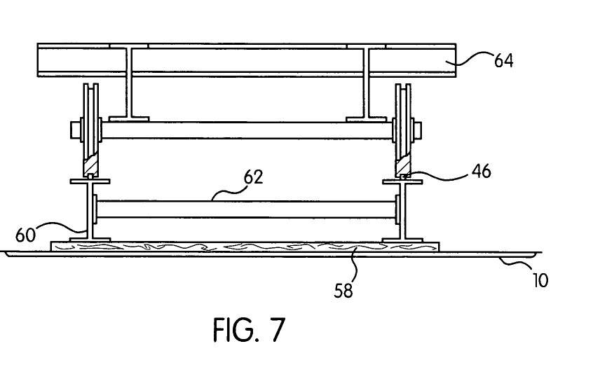

In FIG. 7 a cross-section of the bottom part of the assembly 1 according to the invention is partially depicted. However, different from FIG. 4 the rails 46 are not directly placed on a surface 10 or a wooden plank 58, but additionally T-shaped metal cores 60 are placed on top of the wooden plank 58. Adjacent T-shaped metal cores 60 are connected via one or more pipes 62 which, for example, can be fastened to the metal cores via bolds, so that the weight of the heavy component to be transported does not cause the rails 46 to be pushed apart. As can also be derived from FIG. 7, not only the mobile support means 2 and 4 can be driven on the depicted rail system, but also a trolley 64 with which the dismantled valve can be transported away from the plant.

In the following a method for the replacement of a defective valve which is part of a vertically aligned tube system with the aid of the device according to the invention is described in detail.

In a first step at least two, in particular adjacent, bolts are removed from each side of a flange at the back part of the valve, preferably at more or less the same height. Then, a connecting clamp is fixed to the flange at each side of the bag part of the valve, e.g. by using the aforementioned bolts. The connecting clamps are attached to the back part of the valve in such a way that a straight line drawn between said connecting clamps is essentially perpendicular to the direction of the first movement of the valve during its replacement. Next, the mobile support means are assembled by attaching a height-adjustable connecting device which is already joined to a mobile unit to the connecting clamp by extending the extractable connecting device with the help of a hand wheel. Then, the upper flange of the valve where it is connected with the upper tube is completely unbolted and said tube is very slightly lifted. In a preferred embodiment a cylindrical supporting pipe which extends in the replacement direction is mounted to the front part of the valve, for example to the flange of an inspection port. The front part of the valve and/or the supporting pipe is/are connected to a manual hoist and to an additional chain block. The manual hoist may have a capacity of 15 t whereas the additional chain block may have a capacity of 5 t. Corresponding to the installation of the replacement device according to the invention care has to be taken that the upper and lower flanges to which the valve is connected are unbolt. Therefore, after the hoist and the additional chain block have been adjusted to lift the valve the lower flange which connects the valve with the lower tubing is completely unbolted. Then, the valve can be pulled out of its seat through the hoist and/or a chain block which is connected to the front part or a supporting pipe. As soon as the valve is completely removed from its seat, it can be lowered onto, for example, a trolley by contracting the connecting device through the hand wheels and by releasing the manual hoist. For the sake of safety the trolley is also run on rails. Subsequently the mobile supporting feet, i.e. the connecting device and the mobile unit, are removed from the fastening clamps which are bolted to the flange, and the supporting pipe is removed from the front part of the valve. Then, also the fastening clamps can be removed to be used for further replacement work. Before being placed on the trolley the valve can also be brought in a new position, for example by rotation of for about 90°. The valve can now either be directly released from the trolley by use of a crane, or the trolley can be used to place the valve in a more appropriate position for further transport.

A spare valve can now be installed in reverse order of the aforementioned process steps. Again, use can be made of a supporting pipe to allow for a more safe transfer of the valve when being connected to the manual hoist. In a similar fashion, the fastening means, e.g. fastening clamps, have to be affixed to the bonnet of the valve and to be assembled with the adjustable mobile supporting feet. After the valve has been lifted by extending the mobile supporting feet via the extractable connecting device as well as by use of the manual hoist, it is pulled and/or pushed to its seat via a chain block which is connected to the bonnet flange. After having been properly positioned in its seat the replacement device according to the invention can be dismantled and the valve be connected to the upper and lower flange of the vertically aligned tube system.

It has surprisingly been found that the replacement or removal of heavy equipment by use of the device according to the present invention requires only about one third of the man power which is usually necessary with conventional replacement devices and methods. Equipment as heavy as, for example, 14 tons can be handled without any problems with a limited number of personal, in a much reduced time and under safer conditions. With the device according to the present invention the maintenance time can even be reduced by 75% irrespective of the size and weight of the equipment to be replaced, thereby minimizing the shutdown time of a production plant dramatically which, as a consequence, results in much reduced production loss. The device of the invention can even be assembled during the cooling down time of a plant. Thus, with the present invention a maintenance tool is provided which overcomes a multitude of drawbacks of the state of the art.

Obviously, numerous modifications and variations of the present invention are possible in the light of the above teaching. It is therefore to be understood that within the scope of the attended claims, the invention may be practiced otherwise than as specifically described herein.

1. A replacement assembly (1) for the removal and/or replacement of huge and/or heavy components, in particular as part of a construction or plant unit, comprising:
(a) at least two mobile support means (2,4) each of which comprises a mobile unit (12), in particular at least two wheels (44) which are adapted to be aligned in a row with regard to the moving direction, at least one fastening means (14) adapted to be reversibly fixable, in particular clamped, to, in particular the back part of, said component, and at least one connecting device (16) adapted to connect the mobile unit (12) and the fastening means (14), and;
(b) at least one mounting rail (22) which comprises a lifting device, in particular a hoist, which is moveably supported on said mounting rail and which has connecting means being detachably lockable to, in particular the front part of, said component, in particular via at least one lug, and which is adapted to hold said component from above.

2-22. (canceled)
